(19) United States
(12) Patent Application Publication
(10) Pub. No.: US 2002/0196133 A1
(43) Pub. Date: Dec. 26, 2002

(54) Anti-vehicle theft and anti-hijacking unit combined

(76) Inventor: Leonard Maurice Joynes, Hemet, CA (US)

Correspondence Address: Leonard M. Joynes, 3030 W. Acacia Ave. Apt. V201, Hemet, CA, 92545-3668, US

(21) Appl. No.: 09/886,809

(22) Filed: Jun. 22, 2001

(51) Int. Cl. B60R 25/10

(52) U.S. Cl. 340/426; 340/574

(57) ABSTRACT

This unit will prevent any unathorized person from driving your vehicle by preventing enough electricity to go to the engine

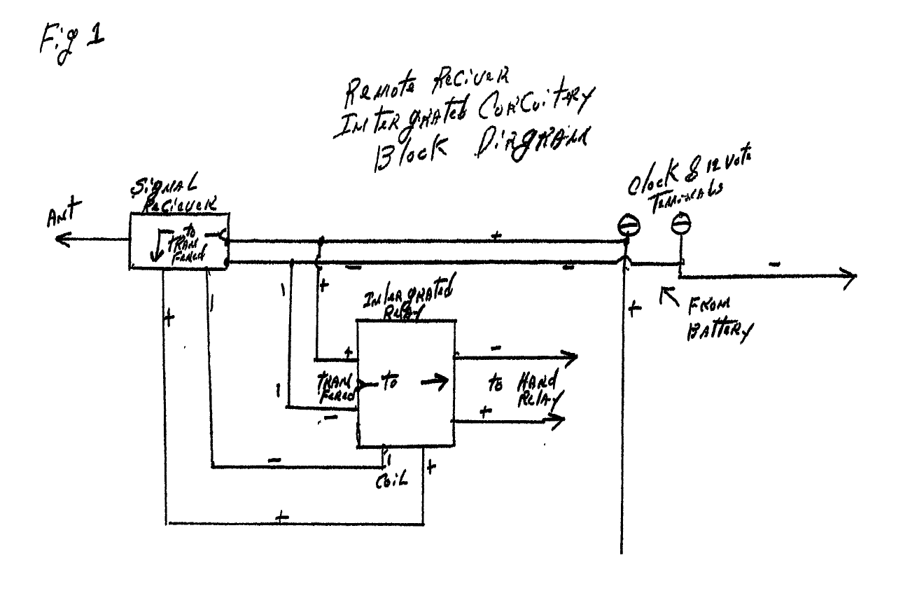

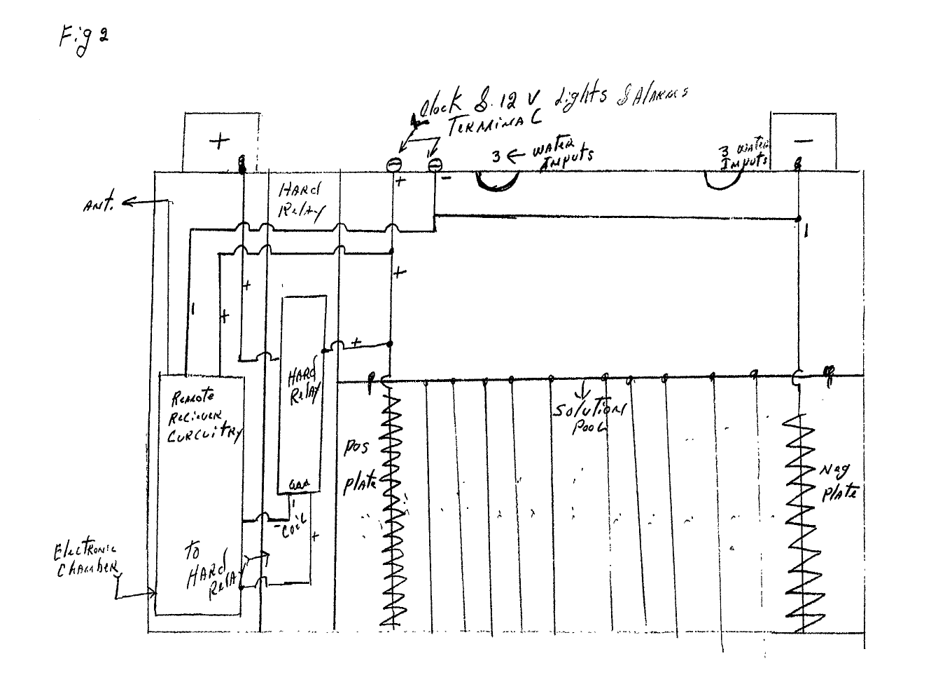

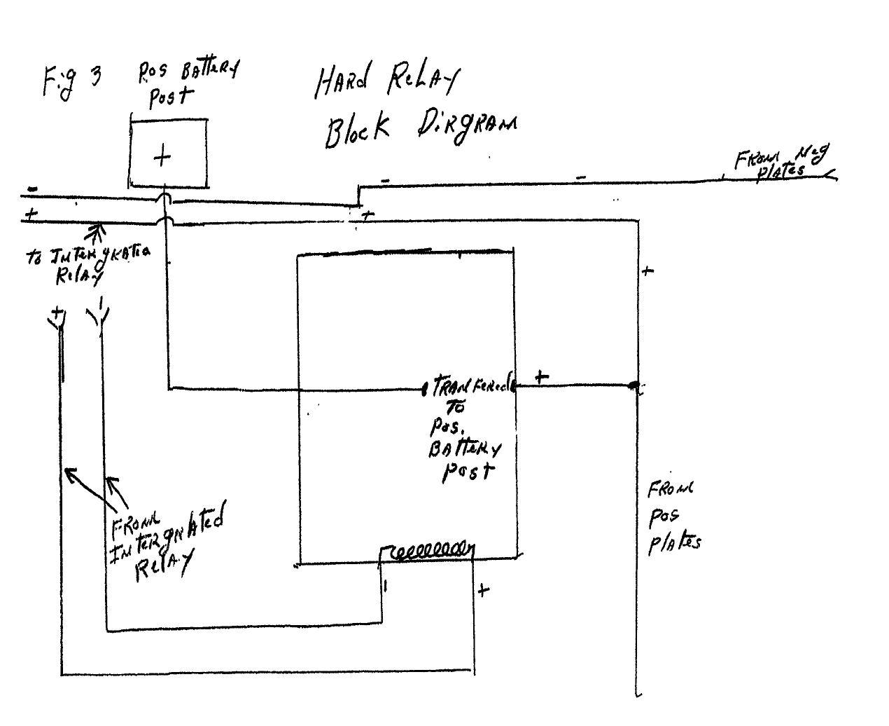

The following is a detailed explanation of how the newly designed anti-vehicle theft/anti-hijacking system works.

This system can be installed in a vehicle as a separate unit that attaches to a regular vehicle battery or can be built into a specially designed battery.

This system when properly installed will prevent a thief from starting, stealing, and driving away with a vehicle. This is accomplished by the power being shut OFF with a remote control unit. The amount of power needed to start the vehicle and drive away is turned off. The amount of power needed to run a vehicle's accessories, lights, radio, and alarm system is still available. When a thief attempts to start the vehicle, once the system has been activated by remote control, the vehicle's battery appears to be dead. The vehicle owner turns on the battery's full power by depressing the On button on his remote control unit.

If the hood of the vehicle is opened while it is parked, a kill switch relay will disable the engine. The engine will not be able to receive power from any battery until the legal owner states the pre-recorded password into the microphone mounted inside the vehicle.

The anti-hijacking/anti-theft unit may be installed in a separate unit or in a specially designed battery. These two components are installed into the same unit or battery. This is a total anti-theft system. The anti-hijacking component requires special cables, microphone and switch to be installed.

Operation of the unit: Before installation, the owner must first have all legal operators of the vehicle record a password onto the voice recognition unit by speaking into the microphone that will later be installed into the vehicle. Once the voice recognition system is installed it will limit a hijacker to approximatly 150 seconds of operation of the vehicle. If a driver side door is open while the car is running, the vehicle will continue to operate normally for approximately 120 seconds. At that time, an indicator light will alert the driver that he has about 25 seconds to repeat a prerecorded password. If the correct password is not repeated by a recognized legal operator, the vehicle will shut down, and a directional locator signal will begin to transmit the vehicle's location. This vehicle can not be started until a recognized legal operator says the correct password. When the door is opened during the normal operation of the vehicle, a switch breaks the relay to the alternator, which shuts down the power coming from the alternator, so that the vehicle is operating on battery power only. There is a delay unit on the relay switch for the battery, which allows power to be transmitted for approximately 150 seconds. At that time the relay to the battery shuts off all power coming from the battery so the vehicle engine will stop operating.

The battery cut off relay can be installed onto the battery or the core, depending on the type of vehicle the system is used on.

### DESCRIPTION OF THE FOUR DIAGRAMS INCLUDED

There are a total of four diagrams included in this application. Each will be explained below.

FIG. #1. This is a diagram of the total battery that can be installed in a vehicle. This battery will be a gel cell or liquid cell battery. At the left of the figure you see the electronic chamber. This camber can be built into the battery or in a box outside of a regular battery.

FIG. #2. This is the anti-hijacking unit. The diagram shows how the alternator power comes into a relay switch. When in normal use and the door is closed alternator power will go straight to the engine and the vehicle will operate normally. If the door is open, while the alternator is generating power, the power is transferred to the battery relay through a timer. After approximately 120 seconds, the timing unit will activate an indicator light. At that time, the operator of the vehicle will have approximately 25 to 30 seconds for the legal operator to say the password. The voice recognition unit will only allow the engine to operate normally if a pre-recorded password stated by a legal operator is recognized. If this does not occur the battery relay will engage the battery and shut off the power. This diagram also displays the hood kill switch relay, which disables the engine until the owner, or his authorized vehicle user, states a pre-recorded password into the microphone mounted into the vehicle.

FIG. #3. This diagram shows the electronic chamber that houses the anti-vehicle theft unit. The chamber contains a remote control unit, a power reduction unit, and a high power relay. The purpose of this unit is to reduce the power output of the battery so that the car can not be started, while still allowing enough voltage to operate the vehicle's accessories. This shows how when the remote receives a signal to shut off, the voltage is transferred to a reduction unit which reduces the power, while still allowing enough power to operate the vehicle's accessories. When the remote signals the on button, the total power of the battery bypasses the reduction unit and goes to the vehicle's engine.

FIG. #4. This diagram shows the silent locator signal, which is engaged if a pre-recorded password stated by a legal operator is not recognized. A directional signal finder meter is included in all sales. This does not use a satellite hookup or any pre-existing system.

This system is sold as a complete system. It does not use any other pre-existing vehicle finding systems.

1. This is a separate system from any other vehicle location device on the market. It is a totally new anti-theft anti-hijacking system, which is designed to prevent vehicle theft, when a vehicle is parked, or running. This system is designed to allow a hijacker to drive far enough away from a victim so as not to endanger a victim's life. The anti-theft section of this system is already assembled and included. The vehicle owner does not have to attach any mechanical apparatus to the exterior or interior of the vehicle every time the vehicle is parked. This system is designed to allow the alarm system on a vehicle to operate even though the volts required to start the vehicle will not be available to start the vehicle. The vehicle thief must first disable the alarm, replace the battery, and hoist the vehicle onto a flat bed truck in order to steal this vehicle. Once the hood is opened a kill switch relay is activated that can only be disengaged by the owner stating the password into the microphone mounted into the vehicle.
